(19) United States
(12) Patent Application Publication
(10) Pub. No.: US 2026/0254175 A1
(43) Pub. Date: Aug. 27, 2026

(54) ELECTRICAL CABLE CONNECTOR WITH INDICATOR LIGHT

(71) Applicant: Aivres Systems Inc., San Jose, CA (US)

(72) Inventor: Chun Kai WANG, Taipei (TW)

(21) Appl. No.: 19/063,477

(22) Filed: Feb. 26, 2025

(51) Int. Cl. H01R 13/717; H01R 12/71; H01R 13/627

(52) U.S. Cl. CPC H01R 13/7175; H01R 12/716; H01R 13/6272

(57) ABSTRACT

Disclosed herein is an electrical cable connector for use in computer systems. The electrical cable connector includes a housing, two conductive paths on the housing, a release tab rotatably attached to the housing at a fulcrum, a conductor mounted on the release tab, and an indicator light. The electrical cable connector releasably engages with a plug connector. The release tab engages with a locking member of the plug connector when the release tab is in a first rotational position, and disengages with the locking member when the release tab is in a second rotational position. The two conductive paths are electrically insulated from each other. The conductor electrically connects the two conductive paths when release tab is in the second rotational position. The indicator light emits light when the two conductive paths are electrically connected by the conductor.

### TECHNICAL FIELD

This disclosure is generally related to an electrical cable connector for use in computer systems.

### BACKGROUND

In computer systems, including workstations and servers, electrical components and associated circuitry are often provided on a motherboard, which is a circuit board generally comprising a flat sheet-like material having a height and a width dimension, the material having a nominal thickness. Various electrical components are mounted to one or both sides of the motherboard. The internal electrical connections between the electrical components located on the motherboard are often formed using electrically conductive traces printed onto or otherwise provided on the material forming the motherboard.

In addition, computer systems frequently include one or more daughter boards (also known as riser cards, piggyback boards, or daughter cards). Daughter boards are smaller circuit boards that are connected to the motherboard and extend the capabilities of the motherboard. They make possible extra features that are not present on the motherboard itself. For example, a daughter board can add memory, storage, network interfaces, graphic processing capabilities, specialized audio processing units, or unique ports for specific tasks.

Electrical cables are often used to transmit electrical signals between a motherboard and a daughter board, or between daughter boards, or to provide electrical power to daughter boards. There are usually electrical connectors at a terminal of a cable and on a circuit board (which can be a motherboard or a daughter board) so that the cable can be secured and fastened on the board. Such connectors often employ an interlocking feature in the form of a tab (known as a release tab or locking tab) to provide increase interlock strength and to ensure proper alignment between mating connectors. In such electrical connectors with a release tab, a pair of mating connectors can only be pulled apart when the release tab is fully depressed.

However, users are usually uncertain about the strength of forces that may be required to fully depress the release tab and to pull apart a pair of mating connectors. It happens frequently that because the release tab is not fully depressed by a user, the pair of mating connectors are still interlocked, and the user, by application of an excessive force, pulls the receptacle connector off the circuit board, or pulls the plug connector off from the end of a cable, or even snaps the cable.

Disclosed here in an electrical cable connector that employs an indicator, which emits light only when the release tab is fully depressed and the electrical cable connector is ready to be pulled apart from its mating partner connector. The electrical cable connector disclosed herein thus prevents any accidental breakage of the connector, the electrical cable, the mating partner connector, or the circuit board.

### SUMMARY

Described herein is an electrical cable connector for use in computer systems.

In one general aspect, disclosed herein is an electrical cable connector comprising a housing; two conductive paths on the housing, a release tab rotatably attached to the housing at a fulcrum, a conductor mounted on the release tab, and an indicator light.

In some embodiments, the electrical cable connector is configured to releasably engage with a plug connector. In some embodiments, the release tab is configured to engage with a locking member of the plug connector when the release tab is in a first rotational position, and to disengage with the locking member when the release tab is in a second rotational position. In some embodiments, the conductor is configured to electrically connect the two conductive paths when release tab is in the second rotational position. In some embodiments, the indicator light is configured to emit light when the two conductive paths are electrically connected by the conductor.

In some embodiments, the housing is an electrical insulator.

In some embodiments, the two conductive paths are electrically insulated from each other. In some embodiments, the two conductive paths are electrically insulated from each other by an air gap. In some embodiments, each of the two conductive paths is a metal wire, rod, bar, or strip, for example. In some embodiments, at least one of the two conductive paths is electrically connected to a source of electrical power.

In some embodiments, the indicator light is a light emitting diode. In some embodiments, the light emitting diode connected electrically in series with a resistor.

In some embodiments, the locking member of the plug connector is a protrusion on the plug connector.

In some embodiments, the release tab is configured to move from the first rotational position to the second rotational position via a rotational motion about the fulcrum when an external force is applied on the release tab. In some embodiments, the release tab is configured to move from the second rotational position back to the first rotational position by a counteracting tension when the external force is removed. In some embodiments, the counteracting tension is supplied by a spring. In some embodiments, the external force is supplied manually by a user. In some embodiments, the indicator light is configured to turn off when the release tab is moved back from the second rotational position.

In some embodiments, the indicator light is configured to turn off when the release tab is in between the first rotational position and the second rotational position.

In another general aspect, disclosed herein is a device comprising a printed circuit board, a light-emitting diode (LED) indicator, and an electrical cable connector mounted on the printed circuit board.

In some embodiments, the printed circuit board comprises a DC (direct current) voltage rail.

In some embodiments, the electrical cable connector comprises a housing, two conductive paths on the housing, a release tab rotatably attached to the housing at a fulcrum, and a conductor mounted on the release tab.

In some embodiments, the two conductive paths are electrically insulated from each other. In some embodiments, at least one of the two conductive paths is electrically connected to the DC voltage rail.

In some embodiments, the electrical cable connector is configured to releasably engage with a plug connector. In some embodiments, the release tab is configured to engage with a locking member of the plug connector when the release tab is in a first rotational position, and to disengage with the locking member when the release tab is in a second rotational position. In some embodiments, the conductor is configured to electrically connect the two conductive paths when release tab is in the second rotational position. In some embodiments, the LED is configured to emit light when the two conductive paths are electrically connected.

In yet another general aspect, disclosed herein is a computer system comprising a motherboard, an LED indicator; and an electrical cable receptacle connector mounted on the motherboard.

In some embodiments, the motherboard comprises a DC voltage rail.

In some embodiments, the electrical cable receptacle connector comprises a housing, two conductive paths on the housing, a release tab rotatably attached to the housing at a fulcrum, and a conductor mounted on the release tab.

In some embodiments, the two conductive paths are electrically insulated from each other. In some embodiments, and at least one of the two conductive paths is electrically connected to the DC voltage rail.

In some embodiments, the release tab is configured to rest at a first rotational position. In some embodiments, the release tab is configured to move from the first rotational position to a second rotational position via a rotational motion about the fulcrum when an external force is applied on the release tab. In some embodiments, the conductor is configured to electrically connect the two conductive paths when release tab is in the second rotational position. In some embodiments, the LED is configured to emit light when the two conductive paths are electrically connected by the conductor.

In some embodiments, the computer system further comprises a plug connector. In some embodiments, the electrical cable receptacle connector is configured to releasably engage with the plug connector.

In some embodiments, the plug connector comprises a protrusion. In some embodiments, the release tab is configured to engage with the protrusion in the first rotational position and lock the electrical cable receptacle connector with the plug connector. In some embodiments, the release tab is configured to disengage with the protrusion in the second rotational position and unlock the electrical cable receptacle connector from the plug connector.

In some embodiments, the computer system further comprises a daughterboard or an extension board. In some embodiments, the plug connector is connected to the daughterboard or the extension board.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the disclosure are utilized, and the accompanying drawings of which:

FIGS. 1A, 1B, and 1C illustrate a receptacle connector with a release tab.

FIGS. 2A and 2B illustrate a receptacle connector with an open conductive path that is closed by fully depressing a release tab.

FIGS. 3A and 3B illustrate a receptacle connector with an indicator LED that is turned on when a release tab is fully depressed.

### DETAILED DESCRIPTION OF EMBODIMENTS

In the following description, certain specific details are set forth in order to provide a thorough understanding of various embodiments of the disclosure. However, one skilled in the art will understand that the disclosure may be practiced without these details. Moreover, while various embodiments of the disclosure are disclosed herein, many adaptations and modifications may be made within the scope of the disclosure in accordance with the common general knowledge of those skilled in this art. Such modifications include the substitution of known equivalents for any aspect of the disclosure in order to achieve the same result in substantially the same way.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Additionally, the singular forms “a,” “an” and “the” include plural referents unless the context clearly dictates otherwise.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiments.

The embodiments will now be explained with the accompanying figures.

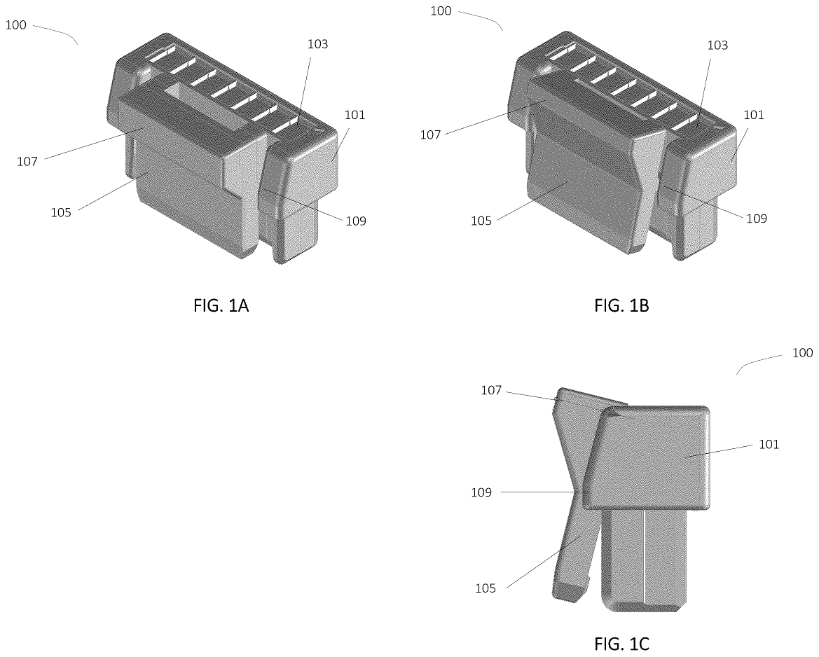

FIG. 1A illustrates a receptacle connector 100, which has an insulative housing 101 with a plurality of cavities 103, each of which contains an electrical contact at the bottom of the cavity. A release tab 105 is attached to the housing 101 at a fulcrum 109. The release tab 105 in FIG. 1A is herein referred to as being in the first rotational position. The release tab 105 is capable of a pivoting motion around the fulcrum 109 when the top portion 107 of the release tab 105 is pressed inwards towards the housing 101. FIG. 1B shows that the when the top portion 107 of the release tab 105 is pressed inwards, the release tab 107 pivots around the fulcrum 109 in a clockwise direction. The release tab 105 in FIG. 1B is herein referred to as being in the second rotational position. FIG. 1C shows a lateral view of FIG. 1B, in which the release tab 105 is the second rotational position.

In some embodiments, the release tab is a spring-loaded lever, and it only pivots around the fulcrum when the applied force can overcome a counteracting tension in the spring; and when the applied force is removed, the tension in the spring causes the release tab to move back to its original position (i.e., the first rotational position).

When a plug connector is fully inserted into the receptacle connector, the release tab engages with a corresponding locking member on the plug connector, and the plug connector and the receptacle connector are interlocked. Thereafter, the plug connector and the receptacle connector cannot be pulled apart unless the release tab on the receptable disengages from the corresponding locking member on the plug connector. In some embodiments, the corresponding locking member is a wedge-shaped protrusion positioned on an outer surface of the plug connector. When the top portion of the release tab is pressed inwards towards the housing of the receptacle connector, the release tab pivots around the fulcrum, and thereby disengages from the corresponding locking member on the plug connector. Only at this point can the plug connector and the receptacle connector be pulled apart.

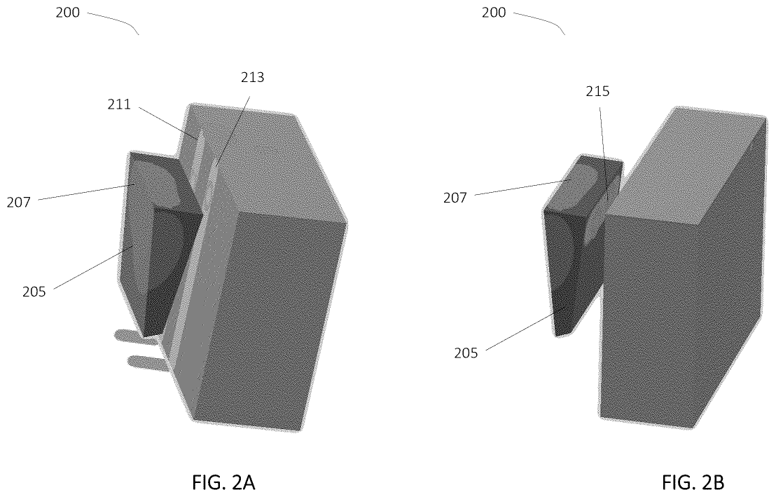

FIG. 2A illustrates a receptacle connector 200 with two conductive paths 211 and 213 on the outer surface of the receptacle connector 200. The two conductive paths 211 and 213 are electrically insulated from each other. In some embodiments, the two conductive paths may be two metal wires, rods, bars, or strips, or they can be made from any other electrically conducting material. As shown in FIG. 2B, the release tab 205 has a conductor 215 mounted at a position on the release tab 205 that faces the two conductive paths 211 and 213, such that when the top portion of the release tab 205 is pressed inwards, the conductor 215 bridges the two conductive paths 211 and 213, and an electrical current may flow from one conductive path to the other. Notably, unless the release tab 205 is fully depressed, the conductor 215 is not in contact with the two conductive paths 211 and 213, and the two conductive paths 211 and 213 remain insulated from each other.

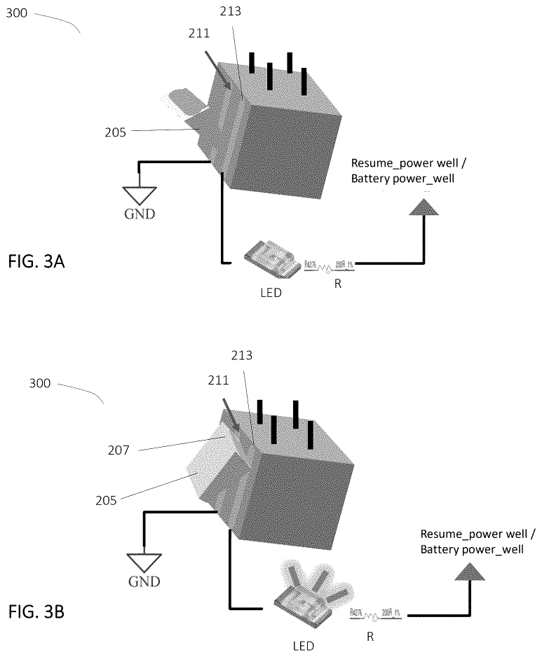

FIG. 3A illustrates an open circuit 300 when the two conductive paths 211 and 213 are not bridged. Conductive path 211 is connected to an electrical ground GND on a circuit board (which can be a computer motherboard, a daughter board, or an extension board). Conductive path 213 is connected, in series, to a light-emitting diode LED, an electrical resistor R, and a positive voltage level. In some embodiments, the positive voltage level may be a battery power well, a resume power well, or a voltage rail at +3.3V, +5V, or +12V. Because the two conductive paths 211 and 213 are electrically insulated from each other, there is not a completed electrical circuit, and therefore the LED is off and does not emit any light. But as shown in FIG. 3B, when the top portion 207 of the release tab 205 is pressed inwards, the conductor (not shown in FIG. 3B) on the release tab 205 bridges the two conductive paths 211 and 213, and an electrical current flows from the positive voltage level to the electrical ground GND via the resistor R and the LED. When the release tab 205 is in this fully pressed position as shown in FIG. 3B, the LED is on and emits light, which signals to a user that he may now pull the plug connector away from the receptacle connector. Notably, if the release tab 205 is not fully pressed (e.g., only pressed to a half-way position), the conductor (not shown in FIGS. 3A and 3B) on the release tab 205 is not in contact with the two conductive paths 211 and 213 and the LED remains off, which signals to the user that he needs to apply a stronger force in pressing the release tab 205.

Although the release tab is on the receptacle connector side according to the above description, alternative embodiments can be implemented in which the release tab is on the plug connector.

The foregoing description of the present disclosure has been provided for the purposes of illustration and description. It is not intended to be exhaustive or to limit the disclosure to the precise forms disclosed. The breadth and scope of the present disclosure should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the disclosure and its practical application, thereby enabling others skilled in the art to understand the disclosure for various embodiments and with various modifications that are suited to the particular use contemplated. It is intended that the scope of the disclosure be defined by the following claims and their equivalence.

What is claimed is:

1. An electrical cable connector comprising:
a housing;
two conductive paths on the housing, wherein the two conductive paths are electrically insulated from each other;
a release tab rotatably attached to the housing at a fulcrum;
a conductor mounted on the release tab; and
an indicator light;
wherein the electrical cable connector is configured to releasably engage with a plug connector;
wherein the release tab is configured to engage with a locking member of the plug connector when the release tab is in a first rotational position, and to disengage with the locking member when the release tab is in a second rotational position;
wherein the conductor is configured to electrically connect the two conductive paths when release tab is in the second rotational position; and
wherein the indicator light is configured to emit light when the two conductive paths are electrically connected by the conductor.

2. The electrical cable connector of claim 1, wherein the housing is an electrical insulator.

3. The electrical cable connector of claim 1, wherein the two conductive paths are electrically insulated from each other by an air gap.

4. The electrical cable connector of claim 1, wherein each of the two conductive paths is a metal wire, rod, bar, or strip.

5. The electrical cable connector of claim 1, wherein at least one of the two conductive paths is electrically connected to a source of electrical power.

6. The electrical cable connector of claim 1, wherein the indicator light is a light emitting diode.

7. The electrical cable connector of claim 6, wherein the light emitting diode connected electrically in series with a resistor.

8. The electrical cable connector of claim 1, wherein the locking member is a protrusion on the plug connector.

9. The electrical cable connector of claim 1, wherein the release tab is configured to move from the first rotational position to the second rotational position via a rotational motion about the fulcrum when an external force is applied on the release tab.

10. The electrical cable connector of claim 9, wherein the release tab is configured to move from the second rotational position back to the first rotational position by a counteracting tension when the external force is removed.

11. The electrical cable connector of claim 10, wherein the counteracting tension is supplied by a spring.

12. The electrical cable connector of claim 10, wherein the external force is supplied manually by a user.

13. The electrical cable connector of claim 10, wherein the indicator light is configured to turn off when the release tab is moved back from the second rotational position.

14. The electrical cable connector of claim 1, wherein the indicator light is configured to turn off when the release tab is in between the first rotational position and the second rotational position.

15. A device comprising:
a printed circuit board comprising a DC voltage rail;
a light-emitting diode (LED) indicator; and
an electrical cable connector mounted on the printed circuit board;
wherein the electrical cable connector comprises:
a housing,
two conductive paths on the housing, wherein the two conductive paths are electrically insulated from each other,
a release tab rotatably attached to the housing at a fulcrum, and
a conductor mounted on the release tab,
wherein the electrical cable connector is configured to releasably engage with a plug connector;
wherein the release tab is configured to engage with a locking member of the plug connector when the release tab is in a first rotational position, and to disengage with the locking member when the release tab is in a second rotational position;
wherein the conductor is configured to electrically connect the two conductive paths when release tab is in the second rotational position; and
wherein the LED is configured to emit light when the two conductive paths are electrically connected.

16. The device of claim 15, wherein at least one of the two conductive paths is electrically connected to the DC voltage rail.

17. A computer system comprising:
a motherboard comprising a DC voltage rail;
a light-emitting diode (LED) indicator; and
an electrical cable receptacle connector mounted on the motherboard;
wherein the electrical cable receptacle connector comprises:
a housing,
two conductive paths on the housing, wherein the two conductive paths are electrically insulated from each other, and at least one of the two conductive paths is electrically connected to the DC voltage rail,
a release tab rotatably attached to the housing at a fulcrum, and
a conductor mounted on the release tab,
wherein the release tab is configured to rest at a first rotational position;
wherein the release tab is configured to move from the first rotational position to a second rotational position via a rotational motion about the fulcrum when an external force is applied on the release tab;
wherein the conductor is configured to electrically connect the two conductive paths when release tab is in the second rotational position; and
wherein the LED is configured to emit light when the two conductive paths are electrically connected by the conductor.

18. The computer system of claim 17, further comprising a plug connector, wherein the electrical cable receptacle connector is configured to releasably engage with the plug connector.

19. The computer system of claim 18, wherein the plug connector comprises a protrusion;
wherein the release tab is configured to engage with the protrusion in the first rotational position and lock the electrical cable receptacle connector with the plug connector; and
wherein the release tab is configured to disengage with the protrusion in the second rotational position and unlock the electrical cable receptacle connector from the plug connector.

20. The computer system of claim 18, further comprising a daughterboard or an extension board, wherein the plug connector is connected to the daughterboard or the extension board.
